(19) United States
(12) Patent Application Publication
(10) Pub. No.: US 2013/0343889 A1
(43) Pub. Date: Dec. 26, 2013

(54) Friction Wheel Drive Train for a Wind Turbine

(71) Applicants: Richard A. Himmelmann, Beloit, WI (US); Stephen E. Tongue, Hampden, MA (US)

(72) Inventors: Richard A. Himmelmann, Beloit, WI (US); Stephen E. Tongue, Hampden, MA (US)

(21) Appl. No.: 13/532,434

(22) Filed: Jun. 25, 2012

(51) Int. Cl. F03D 9/00

(52) U.S. Cl. 416/170 R

(57) ABSTRACT

A constant speed ratio speed increaser friction wheel drive train for a wind turbine is disclosed. The drive train may include at least one drive wheel adapted to receive mechanical energy from a main shaft of a wind turbine and capable of rotating at an input rotational speed, the at least one drive wheel constructed of a plurality of drive wheel segments and at least one driven wheel in contact with and rotating against a surface of the at least one drive wheel at an output rotational speed, the output rotational speed varying with the input rotational speed.

### FIELD OF THE DISCLOSURE

The present disclosure relates generally to wind turbines and, more particularly, relates to friction wheel drive trains for wind turbines.

### BACKGROUND OF THE DISCLOSURE

A utility-scale wind turbine typically includes a set of two or three large rotor blades mounted to a rotor hub. The rotor blades and the rotor hub together are referred to as the rotor. The rotor blades aerodynamically interact with wind and create lift and drag, which is then translated into a driving torque by the rotor hub. The rotor is attached to and drives a main shaft, which in turn is operatively connected via a drive train to a generator or a set of generators that produce electric power. The main shaft, the drive train and the generator(s) are all situated within a nacelle, which is situated on top of a tower.

Many types of drive trains are known for connecting the main shaft to the generator(s). One type of drive train uses various designs and types of speed increasing gearboxes to connect the main shaft to the generator(s). Typically, the gearboxes include one or more stages of gears and a large housing, wherein the stages increase the rotor speed to a speed that is more desirable for driving the generator(s). While effective, large forces translated through the gearbox can deflect the gearbox housing and components therein and displace the large gears an appreciable amount so that the alignment of meshing gear teeth can suffer. When operating with misaligned gear teeth, the meshing teeth can be damaged, resulting in a reduced lifespan. The large size of these gearboxes and the extreme loads handled by them (including transient over torque conditions) make them even more susceptible to deflections and resultant premature wear and damage, such as gear pitting. Furthermore, maintenance and/or replacement of parts of damaged gearboxes may not only be difficult and expensive, it may require entire gearboxes to be lifted down from the wind turbine.

To counteract the disadvantages of traditional gearboxes, some wind turbines have started employing friction wheel drive trains. Friction wheel drive trains replace conventional gearboxes with drive and driven wheels that act as speed increasing stages that drive the generator connected thereto. Motion in friction wheel drive trains is transmitted from the drive wheel to the driven wheel through frictional forces. While the friction wheel drive train alleviates at least some of the problems associated with conventional gearboxes, the friction wheel drive trains that are currently employed are not only inefficient (for example, have greater rolling friction coefficient), but they are also expensive to own, install and maintain and are mostly employed in low power rating wind turbines. Furthermore, currently used friction wheel drive trains wear out faster, requiring frequent repair and replacement of operating parts. In addition, similar to gearboxes, servicing of conventional friction wheel drive trains require them to be hauled down from the wind turbine using expensive hauling equipment. Also, the design of generators used with currently available friction wheel drive trains is not only complex, such generators are bigger in size, cost more and are also difficult to service and maintain.

Accordingly, it would be beneficial if an improved friction wheel drive train were developed that could alleviate at least some of the disadvantages of conventional friction wheel drive trains. For example, it would be beneficial if the improved drive train was easier to service and maintain, had a longer life span, was relatively inexpensive, simplified the design of the generator(s) connected thereto and could be employed with various power rated wind turbines.

### SUMMARY OF THE DISCLOSURE

In accordance with one aspect of the present disclosure, a drive train for a wind turbine is disclosed. The drive train may include at least one drive wheel adapted to receive mechanical energy from a main shaft of a wind turbine and capable of rotating at an input rotational speed, the at least one drive wheel constructed of a plurality of drive wheel segments and at least one driven wheel in contact with and rotating against a surface of the at least one drive wheel at an output rotational speed, the output rotational speed varying with the input rotational speed.

In accordance with another aspect of the present disclosure, a wind turbine is disclosed. The wind turbine may include a hub, a plurality of blades radially extending from the hub and a main shaft rotating with the hub. The wind turbine may further include a drive train comprising (a) at least one drive wheel mounted to the main shaft and rotating at an input rotational speed, the at least one drive wheel constructed of a plurality of drive wheel segments and (b) at least one driven wheel in contact with and rotating against a surface of the at least one drive wheel at an output rotational speed, the output rotational speed varying with the input rotational speed.

In accordance with yet another aspect of the present disclosure, a friction wheel drive train for a wind turbine is disclosed. The friction wheel drive train may include a drive wheel mounted on to a main shaft of a wind turbine and rotating at an input rotational speed, the drive wheel constructed of a plurality of drive wheel segments capable of selective removal for servicing and a plurality of driven wheels arranged symmetrically about the drive wheel and capable of splitting torque into multiple pathways, a rotational axis of each of the driven wheels being co-axial with a rotational axis of the drive wheel, each of the plurality of driven wheels rotating at an output rotational speed, the output rotational speed varying with the input rotational speed and each of the plurality of driven wheels capable of selective removal for servicing.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is an exemplary illustration of a first embodiment of a friction wheel drive train for use within the wind turbine of FIG. 1;

FIG. 3 is an exemplary illustration of a second embodiment of the friction wheel drive train for use within the wind turbine of FIG. 1; and

FIG. 3A is a portion of FIG. 3 in cut-away.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

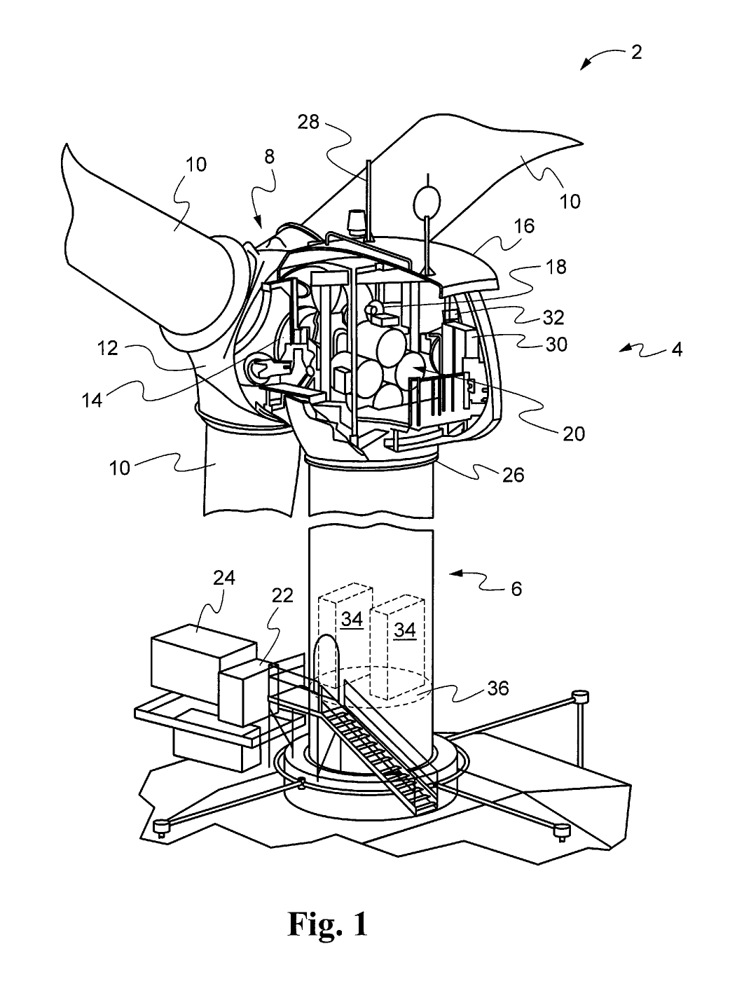

Referring now to FIG. 1, an exemplary wind turbine 2 is shown, in accordance with at least some embodiments of the present disclosure. While all the components of the wind turbine have not been shown and/or described, a typical wind turbine may include an up tower section 4 and a down tower section 6. The up tower section 4 may include a rotor 8 having a plurality of blades 10 connected to a hub 12. The blades 10 may rotate with wind energy and the rotor 8 may transfer that energy to a main shaft 14 situated within a nacelle 16. The nacelle 16 may additionally include a drive train 18 (e.g., a friction wheel drive train, described below), which may connect the main shaft 14 on one end to one or more generators 20 on the other end. The generators 20 may generate power, which may be transmitted from the up tower section 4 through the down tower section 6 to a power distribution panel (PDP) 22 and a pad mount transformer (PMT) 24 for transmission to a grid (not shown). The PDP 22 and the PMT 24 may also provide electrical power from the grid to the wind turbine for powering several components thereof. While the PDP 22 and the PMT 24 have been shown as being situated outside of the wind turbine 2, this need not always be the case.

In addition to the components of the wind turbine 2 described above, the up tower section 4 of the wind turbine may include several auxiliary components, such as, a yaw system 26 on which the nacelle 16 may be positioned to pivot and orient the wind turbine in a direction of the prevailing wind current or another preferred wind direction, a pitch control unit (PCU) (not visible) situated within the hub 12 for controlling the pitch (e.g., angle of the blades with respect to the wind direction) of the blades 10, a hydraulic power system (not visible) to provide hydraulic power to various components such as brakes of the wind turbine, a cooling system (also not visible), a lightning rod 28 for protecting the wind turbine from lightning strikes, and the like. Notwithstanding the auxiliary components of the wind turbine 2 described above, it will be understood that the wind turbine 2 may include several other auxiliary components that are contemplated and considered within the scope of the present disclosure. Furthermore, a turbine control unit (TCU) 30 and a control system 32 (one or both of which may be classified as auxiliary components) may be situated within the nacelle 16 for controlling the various components of the wind turbine 2.

With respect to the down tower section 6 of the wind turbine 2, among other components, the down tower section may include a pair of generator control units (GCUs) 34 and a down tower junction box (DJB) 36 for routing and distributing power between the wind turbine and the grid. Several other components, such as, ladders, access doors, etc., that may be present within the down tower section 6 of the wind turbine 2 are contemplated and considered within the scope of the present disclosure. While a pair of the GCUs 34 has been shown, in at least some embodiments, a single GCU unit or possibly more than two may be present as well.

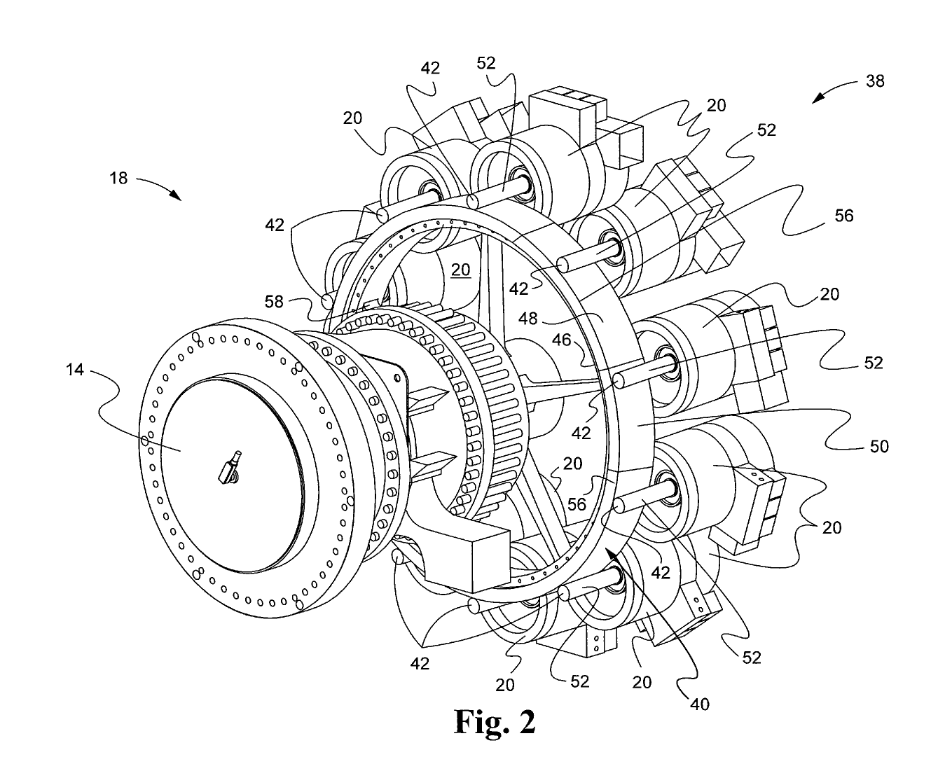

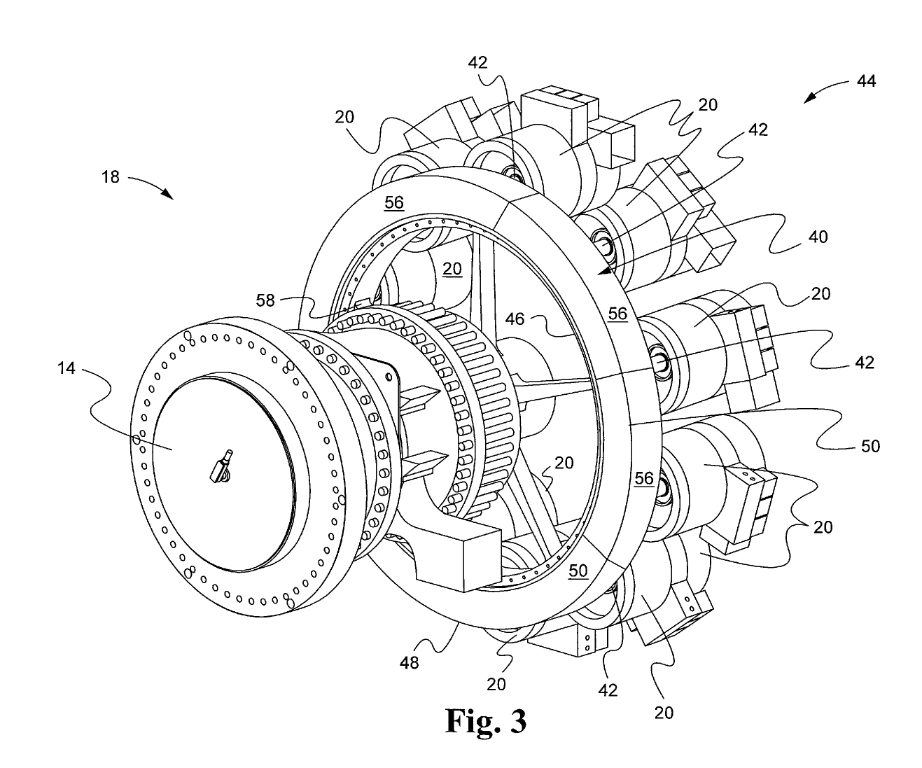

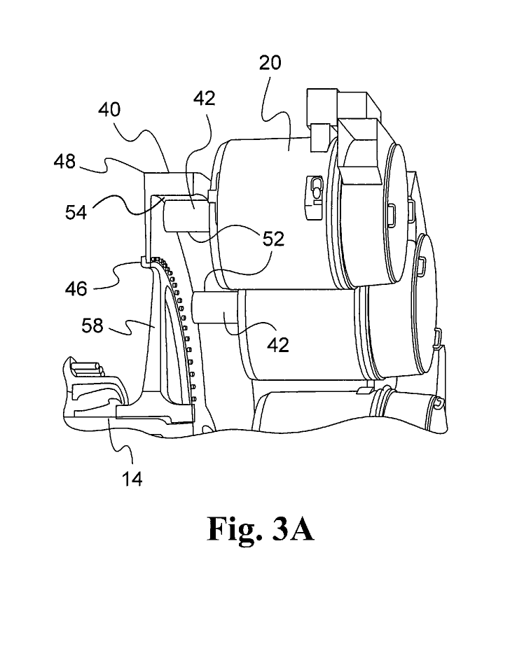

Referring now to FIGS. 2 and 3, first and second embodiments, respectively, of the drive train 18 are shown, in accordance with at least some embodiments of the present disclosure. Particularly, the drive train 18 is a friction wheel drive train. More particularly, the friction wheel drive train of FIG. 2 is an external friction wheel drive train 38 having a drive wheel (also referred to herein as a driving wheel) 40 and a plurality of driven wheels 42 driven by the drive wheel on an outside surface thereof, while the friction wheel drive train of FIG. 3 is an internal friction wheel drive train 44 in which the driven wheels drive on an inner surface of the drive wheel. Referring generally to both FIGS. 2 and 3, the drive wheel 40 may be mounted on to the main shaft 14 for rotation and the driven wheels 42 may be arranged symmetrically (for rotation) about the drive wheel and the main shaft.

“Symmetrical” as used herein to describe the relative positioning of the driven wheels 42 with respect to the drive wheel 40 and the main shaft 14 means that the positioning of these components creates complementary forces on the main shaft and the drive wheel that somewhat cancel one another out. Notwithstanding the symmetrical arrangement of the driven wheels 42 described above, it will be understood that such an arrangement of the driven wheels is not always required. Rather, in at least some embodiments, the driven wheels 42 may be positioned in a non-symmetrical arrangement about the drive wheel 40 and the main shaft 14. Furthermore, in at least some embodiments, the driven wheels 42 may be arranged around the drive wheel 40 such that a rotational axis of each of the driven wheels is co-axial with a rotational axis of the drive wheel. In other embodiments, the driven wheels 42 may be arranged in a non-coaxial fashion around the drive wheel 40.

Furthermore, in at least some embodiments and, as shown, the friction wheel drive trains 38 and 44 may both be single stage constant speed ratio speed increaser drive trains having one set of the drive wheel 40 and the driven wheels 42 in which the drive wheel is larger in size (e.g., larger in diameter) than each of the driven wheels. In at least some embodiments, the drive trains 38 and 44 may be multi-stage constant speed ratio speed increaser drive trains that employ multiple sets of the drive wheel 40 and the driven wheels 42 with each of the drive wheels being larger than each of the driven wheels. For example, for a two stage speed increaser, the drive wheel 40 may drive the driven wheels 42, which in turn may be connected to another one of the drive wheel (e.g., the driven wheels may be sandwiched between two drive wheels) and that drive wheel may drive another set of driven wheels. Depending upon the number of stages of speed increase desired, the number of the stages (each stage having one set of the drive wheel and the driven wheels) of the drive wheel 40 and the driven wheels 42 may vary as well.

Moreover, as stated above, the drive trains 38 and 44 are constant speed ratio speed increaser friction wheel drive trains in which the output rotational speed varies along with the input rotational velocity of the main shaft 14 that drives the drive wheel 40. Thus, for example, if the drive wheel 40 is twice as large in diameter as each of the driven wheels 42, the output shaft connecting the drive wheels to the generator(s) 20 operate at twice the rotational speed of the main shaft 14 (for example, similar to a gear set with twice as many teeth on the drive gear as the driven gear) and if the main shaft speed doubles, the output shaft speed also doubles. In that regard, the friction wheel drive train 18 described herein behaves similarly to a single stage gearbox, but without several of the disadvantages inherent in the conventional gearbox design, as described above and further explained below.

Additionally, the drive wheel 40 and the driven wheels 42 may be constructed of any of a variety of materials. For example, in some embodiments, both the drive wheel 40 and the driven wheels 42 may be constructed of steel (e.g., polished steel or machined steel). By virtue of employing steel for both the drive wheel 40 and the driven wheels 42, a low rolling coefficient of friction (e.g., about 0.002 for machined steel on machined steel, and about 0.0002 for polished steel on polished steel) may be obtained. Since rolling coefficient of friction directly relates to the drag in the energy transfer from one wheel to the other (e.g., from the drive wheel 40 to the driven wheels 42), a lower rolling coefficient of friction may provide for an efficient transfer of power from the drive wheel to the driven wheels. As stated above, steel on steel design of the drive and the driven wheels 40 and 42, respectively, may provide this desired low rolling coefficient of friction. In addition, steel on steel design of the drive wheel 40 and the driven wheels 42 may be less expensive overall given that the physical size of the contact area between the drive and the driven wheels may be smaller, thereby reducing the amount of raw material utilized in constructing the drive and the driven wheels. Furthermore, the wear rates of the steel on steel design may be less compared with the materials employed in conventional friction wheel drive trains. The inventors have found that constructing both the drive wheel 40 and the driven wheels 42 of steel (whether polished or machined steel) may allow the drive trains 38 and 44 to transmit power from the drive wheel to the driven wheel with an efficiency of greater than about ninety nine percent (e.g., 99.97%), not including any bearing losses.

While constructing the drive and the driven wheels 40 and 42, respectively, of steel may advantageously transmit power from the drive wheel to the driven wheels with greater efficiency, in at least some other embodiments, one or both of the drive and the driven wheels may be constructed of other materials, such as but not limited to, rubber, wood and/or possibly plastic. In yet other embodiments, depending upon the efficiency, wheel life span, cost and power requirements that are desired, other types of materials may be employed as well for constructing one or both of the drive wheel 40 and the driven wheels 42.

With respect to the size of the drive wheel 40 and the driven wheels 42, it may vary depending particularly upon the speed ratio of the drive trains 38 and 44 that is desired. Generally speaking, by varying the effective circumference of the drive wheel 40 and the driven wheels 42, a desired speed ratio may be obtained. The shape of the drive wheel 40 and the driven wheels 42 may vary as well. For example and, as shown, the drive wheel 40 and each of the driven wheels 42 may be wheel or disk shaped with the drive wheels being larger in size than the driven wheels in speed increaser drive trains. In at least some embodiments, one or both of the drive wheel 40 and the driven wheels 42 may assume other shapes and configurations, such as but not limited to, conical, tongue and groove (like a v-belt in a pulley) and convex wheel driving against a concave wheel.

Referring still generally to FIGS. 2 and 3, each of the driven wheels 42 may be connected to one of the generators 20. Notwithstanding the fact that in the present embodiment, ten of the driven wheels 42, each connected to one of the generators 20 (for a total of ten generators) has been shown, in at least some embodiments, the number of driven wheels (and the number of generators connected thereto) may vary depending upon the power rating of the wind turbine 2 that is desired. Thus, any power rating of the wind turbine 2 may be achieved by merely varying the number of the driven wheels 42 and the number of generators 20 connected to the driven wheels. In addition, by virtue of employing a plurality of the driven wheels 42 and connecting one of the generators 20 to each of the driven wheels, smaller sized generator units may be employed and the design and complexity of the generators may be significantly simplified compared with conventional friction wheel drive trains that employ a single big generator unit. As will be explained further below, servicing of the generators 20 may be simplified as well and the wind turbine 2 may continue to generate power (using the functional generators units) in the event that one or few of the generators break down and/or are removed for repair and service.

It will be understood that although in the present embodiment, a single one of the generators 20 is connected to each of the driven wheels 42, in at least some embodiments, more than one generator may be connected to each of the driven wheels. Moreover, although in the present embodiment, only a single drive wheel 40 that drives the plurality of driven wheels 42 has been shown, this is merely exemplary. In other embodiments, more than one of the drive wheel 40 driving a single or multiple number of the driven wheels 42 may be employed. Similarly, one or more of the drive wheel 40 driving a single one of the driven wheel 42 may be used as well.

In operation, when the drive wheel 40 is rotated by the wind turbine 2 (e.g., by the rotor 8), and the driven wheels 42 are forced (e.g., rotated) against the drive wheel, rotational motion from the drive wheel is transferred to the driven wheels and torque from the drive wheel is split into multiple pathways to the driven wheels. For an “X” number of the driven wheels 42 that may be employed for each one of the drive wheel 40, the torque may be split into “X” number of pathways. By splitting torque, a reduction of the overall forces on the main shaft 14 that are reacted by main shaft bearings may be achieved. Reducing forces required to be reacted by the main shaft bearings is important in ensuring the longevity of the drive train 18 and/or reducing the cost of the bearings.

Referring specifically now to FIG. 2, the drive train 38 is shown, in accordance with at least some embodiments of the present disclosure. As discussed above, the drive train 38 is an external friction wheel drive train in which the driven wheels 42 rotate against an outer surface of the drive wheel 40. Particularly, the drive wheel 40 may be a substantially wheel shaped structure having an inner wall 46 and an outer wall 48 defining an outer surface 50. The driven wheels 42 may be positioned such that an outer surface 52 of each of the driven wheels is in contact with and rotates against the outer surface 50 of the drive wheel 40. Each of the driven wheels 42 may in turn be connected to one of the generators 20, which rotate along with their respective driven wheels. Furthermore, the drive wheel 40 and the driven wheels 42 may both rotate in the same direction (clockwise or counter clockwise) or they may rotate in opposite directions as well.

Turning now to FIGS. 3 and 3A, the drive train 44 is shown, in accordance with at least some embodiments of the present disclosure. The drive train 44, as discussed above, is an internal friction wheel drive train having the drive wheel 40 driving the plurality of driven wheels 42 along an inner surface thereof, which in turn are connected to the generators 20. In contrast to the drive train 38 in which the driven wheels rotate against the outer surface 50 of the drive wheel 40, the driven wheels rotate against an inner surface of the drive wheel. In particular, the drive wheel 40 may be a substantially disk shaped structure having the inner wall 46 and the outer wall 48 defining the outer surface 50 and an inner surface 54. The driven wheels 42 may be positioned such that the outer surface 52 of each of the driven wheels is in contact with and rotates against the inner surface 54 of the drive wheel 40 (See FIG. 3A). Again, the drive wheel 40 and the driven wheels 42 may both rotate in either the same or counter directions with the generators 20 rotating with their respective driven wheels. Rotating the driven wheels 42 against the inner surface 54 of the drive wheel 40 may advantageously provide a greater speed ratio for a given size of the wind turbine 2.

Referring again generally to both FIGS. 2 and 3, servicing of the drive trains 38 and 44 is described below, in accordance with at least some embodiments of the present disclosure. As discussed above, the drive trains 38 and 44 are designed to facilitate easy repair, replacement and maintenance of the drive wheel 40, the driven wheels 42 and the generators 20. The term “servicing” as used herein means any scheduled or unscheduled maintenance, repair and/or replacement of any of the working and operating parts of the drive trains 38 and 44.

Specifically, the drive wheel 40 may be constructed as a segmented wheel having a plurality of segments 56, which may be positioned on an inner base 58 of the drive wheel. In the event that a portion of the drive wheel 40 needs servicing, instead of removing the entire drive wheel, only the affected segment(s) 56 of the drive wheel may be removed and serviced. By virtue of constructing the drive wheel 40 as a segmented unit, the extra cost, time and labor associated with dismantling the drive wheel, hauling the bulky unit down the wind turbine 2, and re-installing the serviced unit back may be avoided or at least significantly reduced.

Similarly, each of the driven wheels 42 may be constructed such that in the event that one or more of the driven wheels break down, wear out or otherwise need to be serviced, only the affected ones of the driven wheels (and the generators connected thereto) may be dismantled, serviced and installed back. By virtue of allowing selective removal of the driven wheels 42, the drive trains 38 and 44 may continue to function and the wind turbine 2 may continue to generate power utilizing the remaining ones of the driven wheels while the defective driven wheels are serviced. Furthermore, selective servicing of the driven wheels 42 is not only less expensive than traditional friction wheels, it is also more efficient, requires less time and labor. Relatedly, the generators 20 may be selectively removed when one or more of them require any form of servicing while the drive trains 38 and 44 may continue to operate and generate power with the remaining generators.

Thus, the present disclosure sets forth a constant speed ratio speed increaser friction wheel drive train that employs at least one drive wheel and at least one driven wheel to transfer power from the drive wheel to the driven wheel such that the generator rotational speed varies as the wind turbine rotational speed varies. Motion from the at least one drive wheel is transmitted to the at least one driven wheel through frictional forces and particularly, static frictional forces. Specifically, the friction wheel drive train relies on the fact that the static friction of the two wheels, the at least one drive wheel and the least one driven wheel, is greater than their rolling friction. When the at least one drive wheel is rotated by the wind turbine, and the at least one driven wheel is forced against it, rotational motion is transferred from the at least one drive wheel to the at least one driven wheel. Furthermore, the at least one driven wheels may be rotated along an outer or an inner surface of the at least one drive wheel in order to track the output rotational speed with the input rotational speed.

Advantageously, the friction wheel drive trains described above may be employed to reduce the cost and complexity of the wind turbine drive train by eliminating and replacing conventional gearboxes. Furthermore, the friction wheel drive train increases the reliability and decreases the cost of the drive train and associated hardware by significantly reducing the need for precise sprocket location. Since the at least one drive and the driven wheels are not physically connected to one another, they can tolerate misalignment without significantly impacting their performance. In addition, the friction drive train concept increases the robustness of the wind turbine drive train by providing an inherent over-torque safety mechanism. If the wind turbine experiences a dynamic wind gust that momentarily increases the turbine's output torque, the friction wheels can slide against one another, rather than damaging the teeth of a conventional gear mesh.

Thus, the friction wheel speed increaser drive train provides a simple and robust method of increasing the rotational speed of the wind turbine main shaft to a higher rotational velocity. The higher rotational velocity enables the generator size and mass to be reduced, thereby reducing the cost of the generator system and the overall cost of the wind turbine. Higher rotational velocities also tend to increase the fundamental frequency of the electrical output of the generator(s). This higher fundamental frequency reduces the overall size of the power conversion equipment, which also reduces the size, mass, and cost of the power conversion equipment.

While only certain embodiments have been set forth, alternatives and modifications will be apparent from the above description to those skilled in the art. These and other alternatives are considered equivalents and within the spirit and scope of this disclosure and the appended claims.

We claim:

1. A drive train for a wind turbine, the drive train comprising:
at least one drive wheel adapted to receive mechanical energy from a main shaft of a wind turbine and capable of rotating at an input rotational speed, the at least one drive wheel constructed of a plurality of drive wheel segments; and
at least one driven wheel in contact with and rotating against a surface of the at least one drive wheel at an output rotational speed, the output rotational speed varying with the input rotational speed.

2. The drive train of claim 1, wherein the at least one drive wheel comprises one drive wheel and the at least one driven wheel comprises a plurality of driven wheels rotating against the one drive wheel.

3. The drive train of claim 1, wherein the at least one drive wheel is larger in size than each of the at least one driven wheel.

4. The drive train of claim 1, wherein the at least one drive wheel comprises an outer wall defining an outer surface and wherein an outer surface of each of the at least one driven wheel contacts with and rotates against the outer surface of the at least one drive wheel.

5. The drive train of claim 1, wherein the at least one drive wheel comprises an outer wall defining an inner surface and wherein an outer surface of each of the at least one driven wheel contacts with and rotates against the inner surface of the at least one drive wheel.

6. The drive train of claim 1, wherein the at least one drive wheel and the at least one driven wheel are both constructed of machined steel.

7. The drive train of claim 8, wherein the drive train achieves a rolling coefficient of friction of about 0.002.

8. The drive train of claim 1, wherein the at least one drive wheel and the at least one driven wheel are both constructed of polished steel.

9. The drive train of claim 8, wherein the drive train achieves a rolling coefficient of friction of about 0.0002.

10. The drive train of claim 1, wherein the at least one drive wheel transmits power to the at least one driven wheel with an efficiency of greater than ninety nine percent.

11. The drive train of claim 1, wherein each of the plurality of drive wheel segments can be removed individually for servicing.

12. The drive train of claim 1, wherein each of the at least one driven wheel can be selectively removed for servicing with the wind turbine continuing to generate power.

13. A wind turbine, comprising:
a hub;
a plurality of blades radially extending from the hub;
a main shaft rotating with the hub; and
a drive train comprising (a) at least one drive wheel mounted to the main shaft and rotating at an input rotational speed, the at least one drive wheel constructed of a plurality of drive wheel segments; and (b) at least one driven wheel in contact with and rotating against a surface of the at least one drive wheel at an output rotational speed, the output rotational speed varying with the input rotational speed.

14. The wind turbine of claim 13, further comprising at least one generator connected at least indirectly to the at least one driven wheel, the at least one generator rotating at the output rotational speed.

15. The wind turbine of claim 13, wherein the drive train is a multi-stage speed increaser friction wheel drive train.

16. The wind turbine of claim 13, wherein the drive train is a single stage speed increaser friction wheel drive train.

17. The wind turbine of claim 13, wherein the at least one driven wheel is arranged symmetrically around the at least one drive wheel and torque is split into multiple pathways from the at least one drive wheel to the at least one driven wheel.

18. A friction wheel drive train for a wind turbine, comprising:
a drive wheel mounted on to a main shaft of a wind turbine and rotating at an input rotational speed, the drive wheel constructed of a plurality of drive wheel segments capable of selective removal for servicing; and
a plurality of driven wheels arranged symmetrically about the drive wheel and capable of splitting torque into multiple pathways, a rotational axis of each of the driven wheels being co-axial with a rotational axis of the drive wheel, each of the plurality of driven wheels rotating at an output rotational speed, the output rotational speed varying with the input rotational speed and each of the plurality of driven wheels capable of selective removal for servicing.

19. The friction wheel drive train of claim 18, wherein rotational motion is transmitted from the drive wheel to each of the plurality of driven wheels by static frictional forces.

20. The friction wheel drive train of claim 18, wherein the drive wheel and each of the plurality of driven wheels are constructed of steel.
